(19) United States
(12) Patent Application Publication
(10) Pub. No.: US 2009/0205342 A1
(43) Pub. Date: Aug. 20, 2009

(54) AUXILIARY COOLING AND HEATING APPARATUS FOR AUTOMOBILES USING THERMOELECTRIC MODULE

(76) Inventors: Kilsang Jang, Daejeon-si (KR); Yongjun Jee, Daejeon-si (KR)

Correspondence Address: FULBRIGHT & JAWORSKI, LLP, 666 FIFTH AVE, NEW YORK, NY, 10103-3198, US

(21) Appl. No.: 12/374,106

(22) PCT Filed: Jul. 19, 2007
(86) PCT No.: PCT/KR2007/003493

§ 371 Date: Jan. 16, 2009

(30) Foreign Application Priority Data
Jul. 21, 2006 (KR) 10-2006-0068685

(51) Int. Cl. B60H 1/00; F25B 21/04

(52) U.S. Cl. 62/3.3

(57) ABSTRACT

An auxiliary cooling and heating apparatus for automobiles using a thermoelectric module, in which a thermoelectric module is divided into plural ones and supplied with electric power sequentially to reduce inrush current of the thermoelectric module, thereby reducing a load of an electric system of the automobile and increasing durability of the electric system, and enhancing efficiency of the thermoelectric module by controlling capacity in the optimum state.

### TECHNICAL FIELD

The present invention relates to an auxiliary cooling and heating apparatus for automobiles using a thermoelectric module, and more particularly, to an auxiliary cooling and heating apparatus for automobiles using a thermoelectric module, in which a thermoelectric module is divided into plural ones and supplied with electric power sequentially to reduce inrush current of the thermoelectric module, thereby reducing a load of an electric system of the automobile and increase durability of the electric system, and enhancing efficiency of the thermoelectric module by controlling capacity in the optimum state.

### BACKGROUND ART

Recently, due to a high efficiency of an engine according to the demand for an increase of a fuel efficiency of automobiles, since the amount of heat radiated through an engine cooling is reduced, a heat source generated using the amount of heat radiated through the engine cooling runs short in the winter season, and so, additional auxiliary heat source is needed.

For the auxiliary heating, a PTC electric heater, a combustion-type heater, a hot gas system using a refrigerant system, and a heat pump system using a refrigerant system are mainly used now.

The above auxiliary heating devices may respectively have merits and demerits, but, the greatest problem thereof is that they can be used just for an auxiliary heating and cannot be used for an auxiliary cooling.

Particularly, the combustion type system or the heat pump system, which is used at a place requiring a large amount of auxiliary heat source, is expensive, but the PTC electric heater, which is used at a place requiring a small amount of auxiliary heat source, is inexpensive. So, there is a need for an auxiliary heating system which is inexpensive and can supply a large amount of auxiliary heat source.

As a technology for solving the above problems, Japanese Patent Laid-Open Publication No. 1998-035268 discloses an air conditioner. As shown in FIG. 1, the air conditioner includes: a heat exchange unit 4 formed in such a way that a Peltier element 3 (thermoelectric module) is interposed between a water-cooling type heat exchanger 1 and an air-cooling type heat exchanger 2; a waste heat recovery device 5 mounted in an automobile; a fan-mounted radiator 6 connected to the waste heat recovery device 5 in parallel; first and second electronic valves 7 and 8, which are connection-changing means for selectively connecting the waste heat recovery device 5 or the fan-mounted radiator 6 to the water-cooling type heat exchanger 1; and control means for controlling the operations of the first electronic valve 7 and the second electronic valve 8 and converting and controlling the voltage applied to the Peltier element 3.

However, the prior art has a problem in that inrush current is generated greatly when voltage is applied to the Peltier element 3 to thereby impose a burden on electric systems of the automobile.

In addition, the prior art has another problem in that efficiency of thermoelectric module 3 is deteriorated since it is operated in a non-optimum state when its capacity is controlled.

### DISCLOSURE OF INVENTION

### Technical Problem

Accordingly, the present invention has been made to solve the above problems occurring in the prior art, and it is an object of the present invention to provide an auxiliary cooling and heating apparatus for automobiles using a thermoelectric module, in which a thermoelectric module is divided into plural ones and supplied with electric power sequentially to reduce inrush current of the thermoelectric module, thereby reducing a load of an electric system of the automobile and increasing durability of the electric system, and enhancing efficiency of the thermoelectric module by controlling capacity in the optimum state.

### Technical Solution

To achieve the above objects, the present invention provides an auxiliary cooling and heating apparatus for automobiles using a thermoelectric module comprising: a first circulation line formed in such a way as to circulate cooling water by a first pump; a thermoelectric module mounted in such a way that a side thereof heat-exchanges with the first circulation line, the thermoelectric module being divided into plural ones and arranged in series so as to be supplied with electric power sequentially; and heat-exchange means mounted in such a way as to heat-exchange with the other side of the thermoelectric module.

### Advantageous Effects

Since the thermoelectric module is divided into plural ones and the plural thermoelectric modules are sequentially supplied with electric power to thereby reduce (minimize) inrush current of the thermoelectric module, the present invention can reduce a load of the electric system of the automobile and increase durability of the electric system. In addition, since the plural thermoelectric modules are controlled in capacity independently, the present invention can enhance efficiency of the thermoelectric module by controlling their capacity in the optimum state.

Moreover, since the thermoelectric module is divided into plural ones, and cooling water flowing the first circulation line and air (or cooling water) flowing along a radiation fin (or a second circulation line) flow in the opposite direction to each other, the present invention can enhance efficiency of the thermoelectric module by making the temperature difference between both sides of the thermoelectric module uniform.

Furthermore, since the thermoelectric module optimized properly to temperature differences and temperature conditions of the plural thermoelectric modules can be used, the present invention can form the thermoelectric module heat-exchange part of a large scale and increase capacity by enhancing efficiency.

### BRIEF DESCRIPTION OF THE DRAWINGS

FIG. 1 is a configurative view of an air conditioner according to a prior art.

FIG. 2 is a configurative view showing a heating mode of an auxiliary cooling and heating apparatus for automobiles using a thermoelectric module according to a first preferred embodiment of the present invention.

FIG. 3 is a configurative view showing a cooling mode of the auxiliary cooling and heating apparatus for the automobiles using the thermoelectric module according to the first preferred embodiment of the present invention.

FIG. 4 is a configurative view showing a heating mode of an auxiliary cooling and heating apparatus for automobiles using a thermoelectric module according to a second preferred embodiment of the present invention.

FIG. 5 is a configurative view showing a cooling mode of the auxiliary cooling and heating apparatus for the automobiles using the thermoelectric module according to the second preferred embodiment of the present invention.

FIG. 6 is a graph showing a change of electric current when electric power is applied to the thermoelectric module of the auxiliary cooling and heating apparatus according to the present invention.

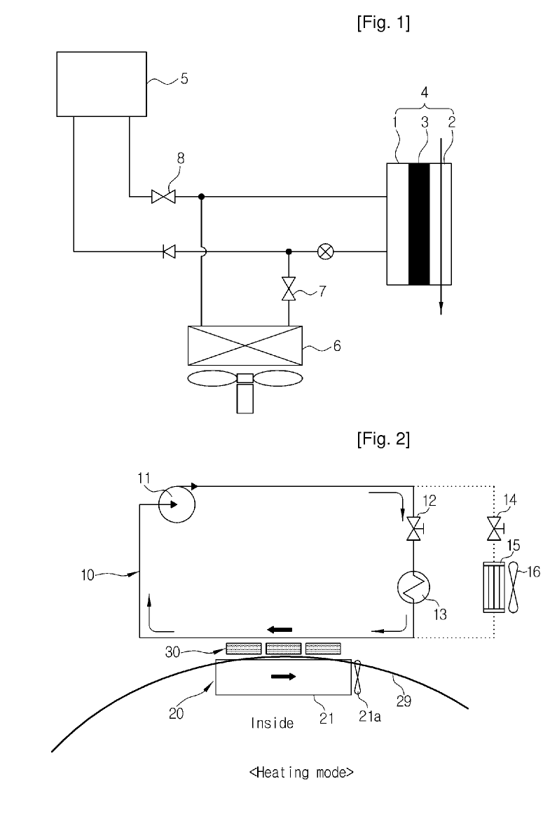

### MODE FOR THE INVENTION

Reference will be now made in detail to the preferred embodiment of the present invention with reference to the attached drawings.

Repeated descriptions of the same configuration and action as the prior art will be omitted.

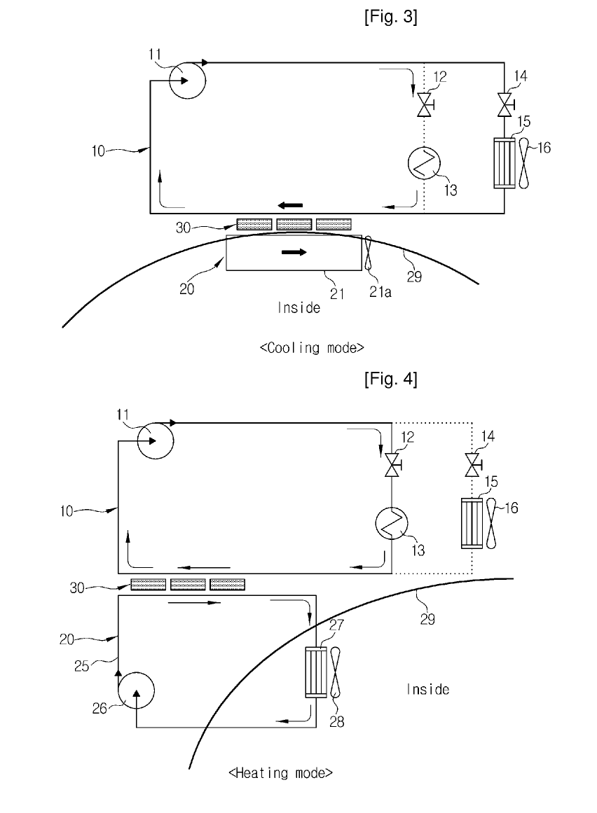

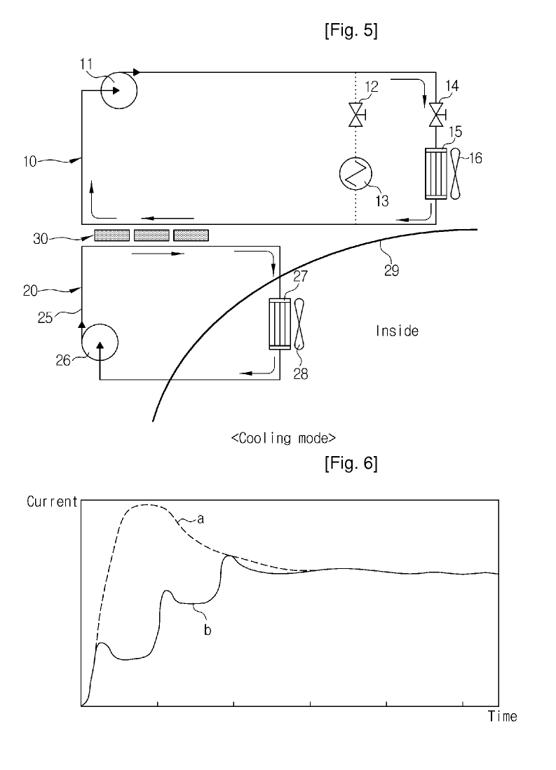

FIG. 2 is a configurative view showing a heating mode of an auxiliary cooling and heating apparatus for automobiles using a thermoelectric module according to a first preferred embodiment of the present invention, FIG. 3 is a configurative view showing a cooling mode of the auxiliary cooling and heating apparatus for the automobiles using the thermoelectric module according to the first preferred embodiment of the present invention, FIG. 4 is a configurative view showing a heating mode of an auxiliary cooling and heating apparatus for automobiles using a thermoelectric module according to a second preferred embodiment of the present invention, FIG. 5 is a configurative view showing a cooling mode of the auxiliary cooling and heating apparatus for the automobiles using the thermoelectric module according to the second preferred embodiment of the present invention, and FIG. 6 is a graph showing a change of electric current when electric power is applied to the thermoelectric module of the auxiliary cooling and heating apparatus according to the present invention.

As shown in the drawings, the auxiliary cooling and heating apparatus for automobiles using the thermoelectric module includes a first water-cooled type circulation line 10, air-cooled type or water-cooled type heat-exchange means 20, and a thermoelectric module 30 mounted in such a way that a side thereof heat-exchanges with the first circulation line 10 and the other side thereof heat-exchanges with the heat-exchange means 20.

First, the thermoelectric module 30 carries out a heat absorbing action at one side thereof and a heat-radiating action at the other side thereof according to a flow direction of electric current. That is, the thermoelectric module 30 can provide both heating and cooling functions since it carries out heat-absorption and heat-radiation at the same time through a conversion of poles (+, −) of electric current.

Such a thermoelectric module 30 performs heat-absorption at one side thereof, which heat-exchanges with the first circulation line 10, and heat-radiation at the other side thereof, which heat-exchanges with the heat-exchange means 20, but performs heat-radiation at one side thereof, which heat-exchanges with the first circulation line 10, and heat-absorption at the other side thereof, which heat-exchanges with the heat-exchange means 20 in a cooling mode.

In addition, the first circulation line 10 is formed in such a way that cooling water circulates the inside thereof by a first pump 11.

In the first circulation line 10, first shutoff valve 12 and heat exchanger 13 and second shutoff valve 14 and heat exchanger 15 are mounted in parallel, so that cooling water passing through the first pump 11 selectively passes through the first heat exchanger 13 or the second heat exchanger 15 in the heating or cooling mode.

That is, in the heating mode, the first shutoff valve 12 is opened but the second shutoff valve 14 is closed, so that cooling water circulated by the first pump 11 heat-exchanges with one side of the thermoelectric module 30 during a process of circulating after passing through the first heat exchanger 13.

However, in the cooling mode, the first shutoff valve 12 is closed but the second shutoff valve 14 is opened, so that cooling water circulated by the first pump 11 heat-exchanges with one side of the thermoelectric module 30 during a process of circulating after passing through the second heat exchanger 15.

As described above, the first shutoff valve 12 and the second shutoff valve 14 are conversion valves used for heating and cooling, and allow cooling water flow to the first heat exchanger 13 since the second shutoff valve 14 is closed when waste heat recovery is needed, but allow cooling water flow to the second heat exchanger 15 since the first shutoff valve 12 is closed when it is necessary to radiate heat to the air.

Here, the first heat exchanger 13 is a heat exchanger for recovering waste heat, is mounted on an exhaust pipe of an engine to perform heat-exchange using waste heat of the engine.

In case of a fuel cell automobile, the first heat exchanger 13 can absorb heat from a fuel cell cooling circuit or a battery/motor cooling circuit, and in case of an engine-type automobile, the first heat exchanger 13 can absorb heat from engine cooling water.

For your reference, in the heating mode, in the first circulation line 10, a cycle is completed in such a way that the thermoelectric module 30 continuously receives heat necessary for heat absorption through the first heat exchanger 13. However, if heat is not supplied, for example, since there is no the first heat exchanger 13, the cycle is not completed, and cooling water is frozen while temperature of cooling water circulating the first circulation line 10 continuously lowers to sub-zero temperature due to the heat-absorbing action of the thermoelectric module 30. As described above, efficiency of the thermoelectric module 30 is enhanced when the heat-absorbing side of the thermoelectric module 30 absorbs heat smoothly using waste heat and the heat-radiating side radiates heat smoothly in the heating mode. Moreover, as heat necessary for heat absorption is more supplied to the heat-absorbing side of the thermoelectric module 30, efficiency is enhanced and heating temperature rises.

Furthermore, the second heat exchanger 15 comprises a radiator for cooling the first circulation line 10 using the outdoor air in the cooling mode. That is, in the cooling mode, since heat is introduced into the first circulation line 10 by the heat-radiating action of the thermoelectric module 30 to rise temperature of cooling water, the first circulation line 10 is cooled by blowing the outdoor air through a fan 16 mounted at a side of the second heat exchanger 15, whereby efficiency of the thermoelectric module 30 is enhanced.

Continuously, the heat-exchange means 20 mounted at the other side of the thermoelectric module 30 comprises an air-cooled type or a water-cooled type.

First, as shown in FIGS. 2 and 3, the air-cooled type heat-exchange means 20 is implemented by including a radiation fin 21 mounted thereon so that it can heat-exchange with the outdoor air at the other side of the thermoelectric module 30. In this instance, the radiation fin 21 is located inside an air-conditioning duct 29 mounted inside the automobile, and performs the heating and cooling functions while heat-exchanging with the blown air.

That is, when the thermoelectric module 30 performs the heat-radiating action against the radiation fin 21, the radiation fin 21 radiates heat to heat the inside of the automobile, but when the thermoelectric module 30 performs the heat-absorbing action against the radiation fin 21, the radiation fin 21 absorbs heat to cool the inside of the automobile.

Additionally, a fan 21a for blowing air may be mounted on a side of the radiation fin 21.

Next, as shown in FIGS. 4 and 5, the water-cooled type heat-exchange means 20 includes a second circulation line 25 formed at the other side of the thermoelectric module 30 in such a way that cooling water is circulated by a second pump 26. A third heat exchanger 27 is mounted on the second circulation line 25 and located inside the air-conditioning duct 29 to perform the heating and cooling functions.

That is, in the heating mode, when the thermoelectric module 30 radiates heat to the second circulation line 25 and the second circulation line 25 becomes a heating line, the third heat exchanger 27 becomes a heat exchanger for heating. So, cooling water discharged from the second pump 26 is introduced into the third heat exchanger 27 in a state where it is heated to a high temperature by receiving heat from the thermoelectric module 30 to thereby heat the inside of the automobile.

In the cooling mode, when the thermoelectric module 30 absorbs heat to the second circulation line 25 and the second circulation line 25 becomes a cooling line, the third heat exchanger 27 becomes a heat exchanger for cooling. So, cooling water discharged from the second pump 26 is introduced into the third heat exchanger 27 in a state where it is cooled to a low temperature by being deprived of heat at the thermoelectric module 30 to thereby cool the inside of the automobile.

Meanwhile, the third heat exchanger 27 is mounted on the downstream side of an evaporator (not shown) disposed inside the air-conditioning duct 29 of the front seat air conditioner of the automobile and provides additional heat source for heating and cooling when the air conditioner cannot provide sufficient heating and cooling performances (at the early stage of engine start) to thereby provide an agreeable indoor environment by quickly heating and cooling the inside of the automobile at the early stage of the engine start. Moreover, a fan 28 may be selectively mounted on a side of the third heat exchanger 27 to heat-exchange with the indoor air.

It is preferable that the thermoelectric module 30 according to the present invention is divided into plural ones and the plural thermoelectric modules 30 are arranged in series to receive electric power sequentially.

That is, each of the thermoelectric modules 30 has an independent power supply circuit, and controlled by a controller (not shown). So, electric power is supplied to the plural thermoelectric modules 30 sequentially, and so, a number of the thermoelectric modules 30 are independently controlled in capacity.

In addition, the plural thermoelectric modules 30 can respectively use the optimized modules according to their temperature and operation conditions, and each power supply circuit of each thermoelectric module 30 makes each thermoelectric module 30 operate in the optimum efficiency.

Particularly, when the system starts, electric power is supplied to the plural thermoelectric modules 30 sequentially to reduce inrush current.

FIG. 6 is a graph showing a change of electric current when electric power is applied to the thermoelectric module. When electric power is applied first, since the thermoelectric module 30 can absorb much energy, a high inrush current value is indicated but a stable current value is indicated since the current value is gradually reduced as time goes.

In this instance, when electric power is applied to the thermoelectric modules 30 simultaneously, like the line a of FIG. 6, the inrush current value is increased, and it has a bad influence on an electric system mounted in the automobile to thereby generate an electric burden, and so a problem that a capacity of the electric system must be increased may occur. That is, if the inrush current is increased instantaneously, the capacity of the electric system of the automobile (a battery, an electric wire, a fuse, a switch, and so on) must be increased to cope with the increased current.

Meanwhile, if electric power is supplied to the plural thermoelectric modules 30 sequentially, like the line b of FIG. 6, the inrush current can be reduced to thereby reduce a load of the electric system and increase durability of the electric system.

In addition, when the thermoelectric modules 30 divided into plural ones are controlled in capacity independently, it has an advantage in that a high efficiency can be kept and the thermoelectric modules 30 can be controlled in capacity.

Meanwhile, the controller controls each thermoelectric module 30 to be operated in the greatest efficiency by operating the necessary heat amount and monitoring operation conditions of the system, for instance, a difference between both sides of the thermoelectric module 30.

Moreover, the capacity of the thermoelectric module 30 can be controlled through a current control by PWM (Pulse Width Modulation). In case of the PWM control, the inrush current can be minimized by raising duties of the thermoelectric modules 30 (linear control of electric current) sequentially.

In case of the air-cooled type heat-exchange means 20, it is preferable that cooling water flowing in the first circulation line 10 and air flowing along the radiation fin 21 flow in the opposite direction to each other from the thermoelectric modules 30.

Moreover, in case of the water-cooled type heat-exchange means 20, it is preferable that cooling water flowing in the first circulation line 10 and cooling water flowing along the second circulation line 25 also flow in the opposite direction to each other from the thermoelectric modules 30.

For instance, in the heating mode, the cooling water flowing in the first circulation line 10 gradually lowers in temperature by the heat-absorbing action of the thermoelectric modules 30 but the air or cooling water flowing along the second circulation line 25 gradually rise in temperature by the heat-radiating action of the thermoelectric modules 30, so that the temperature departure between both sides of each thermoelectric module 30 becomes uniform to thereby enhance efficiency of the thermoelectric modules 30.

Furthermore, since operation temperatures of the plural thermoelectric modules 30 are varied according to locations, the thermoelectric modules 30 optimized properly to operation temperature conditions and temperature differences according to locations can be used. Since the thermoelectric modules 30 are changed in efficiency according to the operation temperature and the temperature difference, if the thermoelectric module 30 is optimized according to the locations, efficiency of a heat exchange part of the thermoelectric module 30 is enhanced and the capacity of the thermoelectric module 30 can be increased into a large scale.

Additionally, since the temperature difference among the plural thermoelectric modules 30 is uniform, the thermoelectric modules 30 can be designed stably and produced conveniently.

Meanwhile, it is preferable that the thermoelectric modules 30 are mounted on the downstream side of the first and second heat exchanger 13 and 15 on the first circulation line 10.

Hereinafter, the operation of the auxiliary heating and cooling apparatus for the automobiles using the thermoelectric module according to the present invention will be described.

### A. Heating Mode

\textcircled{1} Air-cooled Type Heat-exchange Means (FIG. 2)

The thermoelectric module 30 performs the heat-absorbing action against the first circulation line 10, but the heat-radiating action against the radiation fin 21, which is the heat-exchange means 20. In this instance, the first shutoff valve 12 is opened and the second shutoff valve 14 is closed.

So, cooling water of the first circulation line 10 is discharged from the first pump 11, passes through the first heat exchanger 13, heat-exchanges with the thermoelectric module 30, and then, is circulated to the first pump 11. In the above process, cooling water is in a high temperature state by absorbing waste heat of the engine while passing through the first heat exchanger 13, and in this instance, the absorbed heat is used as heat necessary for the heat-absorbing action of the thermoelectric module 30.

Moreover, air moving along the radiation fin 21 flows in the opposite direction to the flow direction of the cooling water of the first circulation line 10, and in the above process, since the radiation fin 21 performs the heat-radiating function by the thermoelectric module 30, which performs the heat-radiating action, the air flowing along the radiation fin 21 reaches a high temperature state to thereby heat the inside of the automobile.

\textcircled{2} Water-cooled Type Heat-exchange Means (FIG. 4)

The thermoelectric module 30 performs the heat-absorbing action against the first circulation line 10, but the heat-radiating action against the second circulation line 25, which is the heat-exchange means 20. In this instance, the first shutoff valve 12 is opened and the second shutoff valve 14 is closed.

So, cooling water of the first circulation line 10 is discharged from the first pump 11, passes through the first heat exchanger 13, heat-exchanges with the thermoelectric module 30, and then, is circulated to the first pump 11. In the above process, cooling water reaches a high temperature state by absorbing waste heat of the engine while passing through the first heat exchanger 13, and in this instance, the absorbed heat is used as heat necessary for the heat-absorbing action of the thermoelectric module 30.

Moreover, cooling water of the second circulation line 25 flows in the opposite direction to the flow direction of the cooling water of the first circulation line 10, namely cooling water discharged from the second pump 26 heat-exchanges with the thermoelectric module 30, and then, is circulated to the second pump 26 after passing through the third heat exchanger 27. In the above process, cooling water reaches a high temperature state by the thermoelectric module 30, which performs the heat-radiating action, and then, is introduced into the third heat exchanger 27 to heat the inside of the automobile.

As described above, in the heating mode, the second circulation line 25 becomes the heating line, and the third heat exchanger 27 becomes the heat exchanger for heating to thereby heat the inside the automobile.

B. Cooling Mode

\textcircled{1} Air-cooled Type Heat-exchange Means (FIG. 3)

The thermoelectric module 30 performs the heat-radiating action against the first circulation line 10, but the heat-absorbing action against the radiation fin 21, which is the heat-exchange means 20. In this instance, the first shutoff valve 12 is closed and the second shutoff valve 14 is opened.

So, cooling water of the first circulation line 10 is discharged from the first pump 11, passes through the second heat exchanger 15, heat-exchanges with the thermoelectric module 30, and then, is circulated to the first pump 11. In the above process, cooling water reaches a high temperature state by the heat-radiating action of the thermoelectric module 30 radiates heat through the second heat exchanger 15, namely, the second heat exchanger 15 cools the first circulation line 10 using the outdoor air.

Moreover, air moving along the radiation fin 21 flows in the opposite direction to the flow direction of the cooling water of the first circulation line 10, and in the above process, since the radiation fin 21 performs the heat-absorbing function by the thermoelectric module 30, which performs the heat-absorbing action, the air flowing along the radiation fin 21 reaches a low temperature state to thereby cool the inside of the automobile.

\textcircled{2} Water-cooled Type Heat-exchange Means (FIG. 5)

The thermoelectric module 30 performs the heat-radiating action against the first circulation line 10, but the heat-absorbing action against the second circulation line 25, which is the heat-exchange means 20. In this instance, the first shutoff valve 12 is closed and the second shutoff valve 14 is opened.

So, cooling water of the first circulation line 10 is discharged from the first pump 11, passes through the second heat exchanger 15, heat-exchanges with the thermoelectric module 30, and then, is circulated to the first pump 11. In the above process, cooling water reaches a high temperature state by the heat-radiating action of the thermoelectric module 30 radiates heat through the second heat exchanger 15, namely, the second heat exchanger 15 cools the first circulation line 10 using the outdoor air.

Moreover, cooling water of the second circulation line 25 flows in the opposite direction to the flow direction of the cooling water of the first circulation line 10, namely cooling water discharged from the second pump 26 heat-exchanges with the thermoelectric module 30, and then, is circulated to the second pump 26 after passing through the third heat exchanger 27. In the above process, cooling water reaches a low temperature state by the thermoelectric module 30, which performs the heat-absorbing action, and then, is introduced into the third heat exchanger 27 to cool the inside of the automobile.

As described above, in the cooling mode, the second circulation line 25 becomes the cooling line, and the third heat exchanger 27 becomes the heat exchanger for cooling to thereby cool the inside the automobile.

### INDUSTRIAL APPLICABILITY

As described above, since the thermoelectric module is divided into plural ones and the plural thermoelectric modules are supplied with electric power sequentially to thereby reduce (minimize) inrush current of the thermoelectric module, the present invention can reduce a load of the electric system of the automobile and increase durability of the electric system. In addition, since the plural thermoelectric modules are controlled in capacity independently, the present invention can enhance efficiency of the thermoelectric module by controlling their capacity in the optimum state.

Moreover, since the thermoelectric module is divided into plural ones, and cooling water flowing the first circulation line and air (or cooling water) flowing along the radiation fin (or the second circulation line) flow in the opposite direction to each other, the present invention can enhance efficiency of the thermoelectric module by making the temperature difference between both sides of the thermoelectric module uniform.

Furthermore, since the thermoelectric module optimized properly to the temperature differences and temperature conditions of the plural thermoelectric modules can be used, the present invention can form the thermoelectric module heat-exchange part of the large scale and increase capacity by enhancing efficiency.

1. An auxiliary cooling and heating apparatus for automobiles using a thermoelectric module comprising:
a first circulation line formed in such a way as to circulate cooling water by a first pump;
a thermoelectric module mounted in such a way that a side thereof heat-exchanges with the first circulation line, the thermoelectric module being divided into plural ones and arranged in series so as to be supplied with electric power sequentially; and
heat-exchange means mounted in such a way as to heat-exchange with the other side of the thermoelectric module.

2. The auxiliary cooling and heating apparatus according to claim 1, wherein a first shutoff valve and a first heat exchanger and a second shutoff valve and a second heat exchanger are mounted in parallel on the first circulation line such that cooling water passing through a first pump selectively passes through the first or second heat exchanger in a cooling or heating mode.

3. The auxiliary cooling and heating apparatus according to claim 1, wherein the heat-exchange means comprises a radiation fin mounted thereon so that it can heat-exchange with the outdoor air at the other side of the thermoelectric module, the radiation fin being located inside an air-conditioning duct mounted inside the automobile to thereby perform cooling or heating mode.

4. The auxiliary cooling and heating apparatus according to claim 1, wherein the heat-exchange means comprises a second circulation line mounted at the other side of the thermoelectric module so as to circulate cooling water by a second pump, the second circulation line having a third heat exchanger located inside the air-conditioning duct mounted inside the automobile to thereby perform the cooling or heating mode.

5. The auxiliary cooling and heating apparatus according to claim 1, wherein the capacity of the thermoelectric module is controlled through a current control by Pulse Width Modulation.
